(19) United States
(12) Patent Application Publication
(10) Pub. No.: US 2018/0279714 A1
(43) Pub. Date: Oct. 4, 2018

(54) HIGH-ENERGY POWER GENERATION DEVICE FOR CASUAL SHOES

(71) Applicant: SHEN ZHEN SL SOLAR CO., Ltd, Shenzhen City (CN)

(72) Inventors: Dehui Deng, Miaoshi Town (CN); Yansheng Zhao, Jinzhou (CN); Anjing Zhu, Shenzhen City (CN)

(21) Appl. No.: 15/926,514

(22) Filed: Mar. 20, 2018

(30) Foreign Application Priority Data
Mar. 31, 2017 (CN) 201710208836.4

(51) Int. Cl. A43B 3/00; H02K 7/116; H02J 7/00; H02J 50/00

(52) U.S. Cl. CPC A43B 3/0015; H02K 7/116; H02J 2007/0062; H02J 50/00; H02J 7/0052

(57) ABSTRACT

This disclosure discloses a high-energy power generation device for casual shoes, comprising a battery, a motor, a worm, a forward transmission crown gear, a transmission gear set, a backward transmission crown gear and a planetary gear set. This disclosure provides an efficient high-energy power generation device, which is concise in structure and exquisite in design. By the transmission design of the forward transmission crown gear, the transmission gear set, the backward transmission crown gear and the planetary gear set, this disclosure can generate power when the feet are pedaled down or lifted up, and power generation efficiency is doubled totally.

### PRIORITY CLAIM

This application claims the benefit of the filing date of Chinese Application Serial No. CN201710208836.4, filed Mar. 31, 2017, for “HIGH-ENERGY POWER GENERATION DEVICE FOR CASUAL SHOES.”

### TECHNICAL FIELD

This disclosure relates to the field of power generation devices, and in particular to a high-energy power generation device for casual shoes.

### BACKGROUND

Human social and leisure activities start from feet, especially outdoor activities. Travelling thousands of miles and viewing scenes all over the world require a lot of walking. However, walking, the essential movement of human body, was considered as the largest passive consumption of physical energy in the past. Supplementation for such energy consumption becomes a fundamental restriction on the radius of people's walking. Moreover, in a complex environment or in an accident, slight cerebral concussion or even serious bone contusion may be caused by acute contact between the human body and the ground. In order to solve the above problems, power generation shoes are proposed using walking kinetic energy to generate power. But they are not implemented due to low efficiency, a small power generating capacity, a short service life, complex structures, high manufacturing cost, and the like.

At present, there is a pedaling power generator, which is mainly formed by taking a power generator as a main body and a lever as a supplement with conversion and combination. A pinion is added on the bearing part of the power generator, is placed in the existing space of a stair, and is connected to the surface of the stair by the lever. When people walk, the power generator generates electric energy for use.

After the pedaling power generator is placed in the designated position of the stair, the arc-shaped lever is fixed in a folding point of two steps. The lever is divided into a pedal, a fulcrum, a lever arm and a saw tooth plate. The saw tooth plate is meshed with a gear of the power generator. When the pedal is pedaled to move downwards, the lever will transmit motion and expand a motion range; therefore, the power generator generates power. In order to ensure full contact between saw teeth of the lever and the gear to prevent the saw teeth from departing from the gear due to arc motion of the saw teeth, a spring system is added on the back part of the power generator and is provided in a compressed state, such that the power generator can integrally move in a horizontal direction, but cannot move in the vertical direction. Two storage batteries are mounted on an electrical energy output end of the power generator. When the pedal moves, an elastic piece of the power generator is caused to make contact with the different storage batteries to store currents in different directions. However, the device has the following defects: 1, the currents are different in direction; 2, two groups of batteries are required to match with the currents in different directions; and 3, the power generation device has no portability and needs to match with a fixed position of the stair; otherwise, power cannot be generated anyplace anytime. Therefore, the prior art has defects.

### BRIEF SUMMARY

An object of this disclosure is to overcome the defects of the prior art and provide a high-energy power generation device for casual shoes.

A technical solution of this disclosure is as follows. The high-energy power generation device for casual shoes comprises a battery, a motor, a worm, a forward transmission crown gear, a transmission gear set, a backward transmission crown gear and a planetary gear set. The worm is meshed with a through hole in the center of the forward transmission crown gear. The planetary gear set nests the periphery of the forward transmission crown gear and is meshed with the periphery of the forward transmission crown gear. The backward transmission crown gear nests the periphery of the forward transmission crown gear, is disposed above the planetary gear set, and is meshed with a gear in the planetary gear set. The backward transmission crown gear is meshed with a gear in the transmission gear set. The gear in the transmission gear set is meshed with a gear of the motor. The motor is connected to the battery. When the worm moves vertically, the forward transmission crown gear is driven to rotate to drive the gear in the planetary gear set to rotate to cause the backward transmission crown gear to rotate. Then the backward transmission crown gear causes the power generator to generate power by the transmission gear set.

Further, the worm is a dual-tooth worm. A linear bearing is arranged below each of two support pillars of the dual-tooth worm respectively. A compression spring sleeves the periphery of the linear spring. The high-energy power generation device further comprises a spring cover, and the spring cover is disposed on the bottom of the forward transmission crown gear. The bottoms of the two compression springs are disposed on the spring cover respectively.

Further, the planetary gear set comprises a planetary outer gear, a plurality of forward positioning clips and planetary gears. The planetary outer gear nests the periphery of the forward transmission crown gear. The forward positioning clips and the planetary gears are disposed on the planetary outer gear alternately. One ends of the forward positioning clips are fixed on the planetary outer gear, and the other ends thereof clamp the meshing teeth on the side surface of the forward transmission crown gear. The planetary gears are conical teeth. One surfaces of the planetary gears are meshed with meshing teeth on the bottom of the forward transmission crown gear, while the other surfaces of the planetary gears are meshed with the meshing teeth on the bottom of the backward transmission crown gear.

Further, the transmission gear set comprises a first transmission gear and a second transmission gear. The backward transmission crown gear is meshed with the first transmission gear. The first transmission gear is meshed with the second transmission gear. The second transmission gear is meshed with the gear of the motor.

Further, the high-energy power generation device further comprises a backward positioning clip and an extension spring. One end of the backward positioning clip is fixed on the spring cover by the extension spring, and the other end of the backward positioning clip is clamped on meshing teeth on the outer surface of the planetary outer gear.

Further, the high-energy power generation device further comprises two thrust bearings. One of the two thrust bearings is disposed above the backward transmission crown gear on the periphery of the worm, while the other of the two thrust bearings is disposed below the forward transmission crown gear.

Further, the high-energy power generation device further comprises an upper cover and a lower cover which can be buckled together. The battery, the motor, the forward transmission crown gear, the transmission gear set, the backward transmission crown gear and the planetary gear set are disposed between the upper cover and the lower cover. The upper end of the worm extends out of the surface of the upper cover. The high-energy power generation device further comprises a pedal, and the pedal is disposed above the worm.

The high-energy power generation device further comprises a circuit board. The circuit board is disposed between the motor and the battery.

Further, the battery is configured to charge an external electrical appliance. Charging of the battery is performed using a universal interface or wirelessly.

By adopting the above solution, this disclosure provides an efficient high-energy power generation device with a concise structure and an exquisite design. By the transmission design of the forward transmission crown gear, the transmission gear set, the backward transmission crown gear and the planetary gear set, this disclosure can generate power when the feet are pedaled down or lifted up, and power generation efficiency is doubled totally.

### BRIEF DESCRIPTION OF THE DRAWINGS

FIG. 1 is an exploded view of this disclosure.

FIG. 2 is a structural schematic view of this disclosure.

FIG. 3 is a schematic view of a part of a structure of this disclosure.

FIG. 4 is a longitudinal sectional view of a part of the structure of this disclosure.

FIG. 5 is a transverse sectional view of a part of the structure of this disclosure.

FIG. 6 is specific embodiments of this disclosure.

### DETAILED DESCRIPTION

This disclosure is further explained in combination with drawings and embodiments.

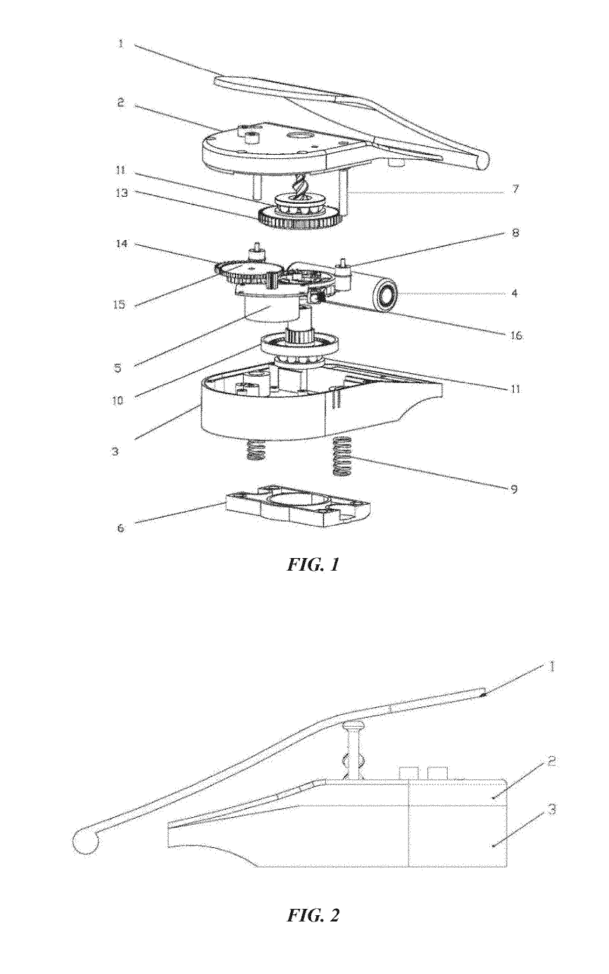

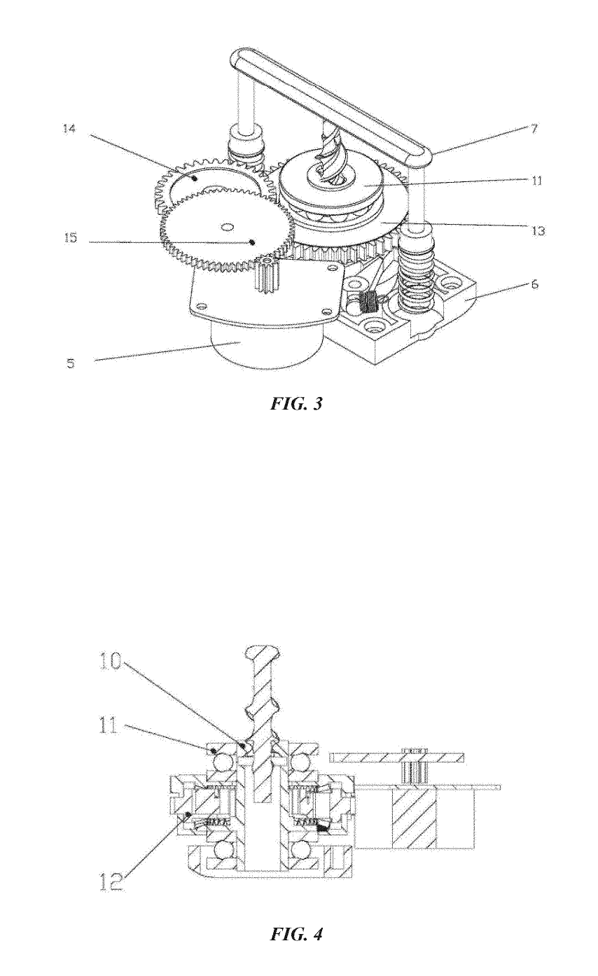

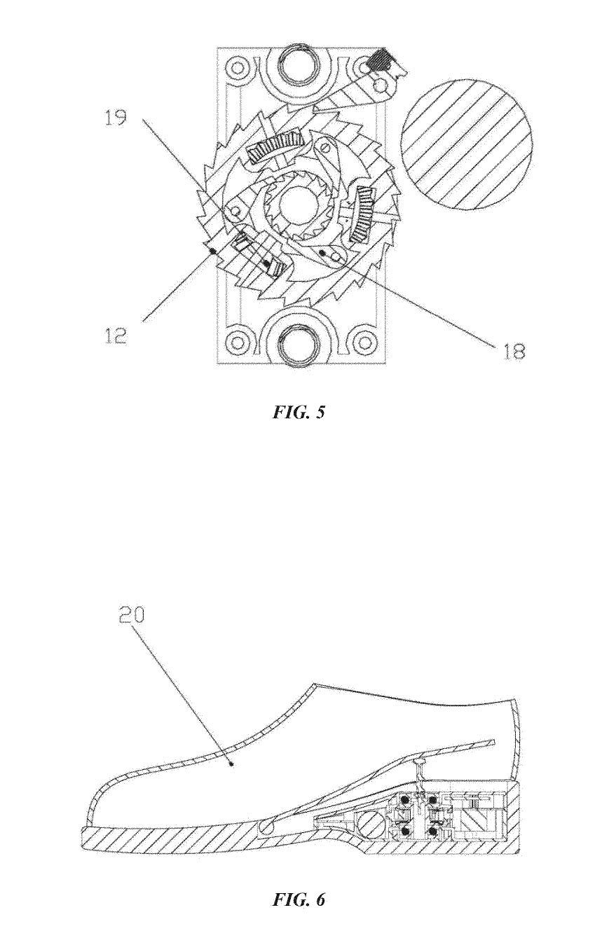

Referring to FIGS. 1 to 5, this disclosure provides a high-energy power generation device for casual shoes, which comprises a worm, an upper cover 2 and a lower cover 3 which can be buckled together, as well as a battery 4, a motor 5, a forward transmission crown gear 10, a transmission gear set, a backward transmission crown gear 16 and a planetary gear set which are disposed between the upper cover 2 and the lower cover 3.

The upper end of the worm extends out of the surface of the upper cover 2. The high-energy power generation device further comprises a pedal 1 disposed above the worm. The worm is meshed with a through hole in the center of the forward transmission crown gear 10. The planetary gear set nests the periphery of the forward transmission crown gear 10 and is meshed with the periphery of the forward transmission crown gear 10. The backward transmission crown gear 16 nests the periphery of the forward transmission crown gear 10, is disposed above the planetary gear set and is meshed with a gear in the planetary gear set. The backward transmission crown gear 16 is meshed with a gear in the transmission gear set. The gear in the transmission gear set is meshed with the gear of the motor 5, and the motor 5 is connected to the battery 4.

It should be noted that a circuit board is further disposed between the motor 5 and the battery 4. The electrical energy generated by the motor 5 firstly flows into the circuit board and is then transmitted to be stored in the battery 4 after flowing into the circuit board. The electric energy stored in the battery 4 can be configured to charge an external electrical appliance (for example, a mobile phone). Charging of the battery may be performed using a universal interface or wirelessly.

Further, the worm is a dual-tooth worm 7. Threads of the dual-tooth worm 7 are meshed with a through hole in the center of the forward transmission crown gear 10. A linear bearing 8 is arranged below each of two support pillars of the dual-tooth worm 7 respectively. A compression spring 9 sleeves the periphery of the linear spring 8. The high-energy power generation device further comprises a spring cover disposed on the bottom of the forward transmission crown gear 10. The bottoms of the two compression springs 9 are disposed on the spring cover respectively. The high-energy power generation device further comprises a backward positioning clip and an extension spring 17. One end of the backward positioning clip is fixed on the spring cover by the extension spring 17, and the other end of the backward positioning clip is clamped on meshing teeth on the outer surface of the planetary outer gear.

The planetary gear set nests the periphery of the forward transmission crown gear 10. The planetary gear set comprises a planetary outer gear 12, three forward positioning clips 18 and three planetary gears 19. The planetary outer gear 12 nests the periphery of the forward transmission crown gear 10. The forward positioning clips 18 and the planetary gears are disposed on the planetary outer gear 12 alternately. One ends of the forward positioning clips 18 are fixed on the planetary outer gear 12, and the other ends thereof clamp the meshing teeth on the side surface of the forward transmission crown gear 10. The planetary gears 19 are conical teeth. One surfaces of the planetary gears 19 are meshed with meshing teeth on the bottom of the forward transmission crown gear 10 at the bottom, while the other surfaces of the planetary gears are meshed with the meshing teeth on the bottom of the backward transmission crown gear 16. The backward transmission crown gear 16 nests the periphery of the forward transmission crown gear 10, is disposed above the planetary gear set and is meshed with the gear in the planetary gear set. The backward transmission crown gear 16 is meshed with the gear in the transmission gear set.

The transmission gear set comprises a first transmission gear 14 and a second transmission gear 15. The backward transmission crown gear 16 is meshed with the first transmission gear 14. The first transmission gear 14 is meshed with the second transmission gear 15. The second transmission gear 15 is meshed with an output shaft of the motor 5.

The high-energy power generation device further comprises two thrust bearings 11. One of the two thrust bearings 11 is disposed above the backward transmission crown gear 16 on the periphery of the worm 7, while the other of the two thrust bearings is disposed below the forward transmission crown gear 10.

A working principle of this disclosure is as follows.

When the pedal 1 is pedaled down, the dual-tooth worm 7 moves downwards. Since the dual-tooth worm 7 is meshed with the forward transmission crown gear, the forward transmission crown gear is driven to rotate; at this point, the three forward positioning clips 18 in the planetary gear set stop the planetary outer gear 12 from moving, and the planetary outer gear 12 is allowed to only rotate along with the forward transmission crown gear 10. Due to the characteristics of the planetary gear 19, at this point, the backward transmission crown gear on the upper part can only synchronously rotate in the same direction along with the forward transmission crown gear 10. The backward transmission crown gear transmits power to the next transmission tooth, thereby finishing a transmission process of downward pedaling.

At this point, the meshing between the dual-tooth worm 7 and the forward transmission crown gear 10 is disengaged, and the forward transmission crown gear 10 continues rotating due to inertia. When the feet are lifted up, the pedal 1 and the dual-tooth worm 7 are lifted upwards due to a counteraction force of the compression springs 9. The dual-tooth gear 7 is meshed with the forward transmission crown gear 10 again; the forward transmission crown gear 10 starts to rotate backwards. Meanwhile, the three forward positioning clips 18 lose effects due to backward rotation; at this point, the planetary outer gear 12 is fixed by the backward positioning clip and cannot rotate, and the integral planetary gears 19 start the transmission to drive the backward transmission crown gear on the upper part. At this point, the backward transmission crown gear is unchanged in transmission direction, so that the transmission from the pedaling down and lifting up of the teeth without direction change is finished. Finally, the meshing between the worm and the forward transmission crown gear 10 is disengaged, and the forward transmission crown gear 10 is allowed to continuously move due to inertia.

Referring to FIG. 6, as an embodiment, this disclosure may be placed in the heel 20 of a shoe 20, such that the pedal 1 is fully fitted with the heel. When the pedal 1 and the compression springs 9 drive the dual-tooth worm 7 to move vertically, the forward transmission crown gear 10 is then driven to rotate, so as to drive the gear in the planetary gear set to rotate. The backward transmission crown gear 16 is caused to rotate, and then the backward transmission crown gear 16 causes the power generator 5 to generate power by the transmission gear set.

In conclusion, this disclosure provides an efficient high-energy power generation device with a concise structure and an exquisite design. By the transmission design of the forward transmission crown gear, the transmission gear set, the backward transmission crown gear and the planetary gear set, this disclosure can generate power when the feet are pedaled down or lifted up, and power generation efficiency is doubled totally.

Only preferable embodiments of this disclosure are provided in the preceding text and are not intended to limit this disclosure. Any modification, equivalent replacement and improvement made within the spirit and principle of this disclosure shall be included within the protection scope of this disclosure.

What is claimed is:

1. A high-energy power generation device for casual shoes, comprising a battery, a motor, a worm, a forward transmission crown gear, a transmission gear set, a backward transmission crown gear and a planetary gear set, wherein the worm is meshed with a through hole in the center of the forward transmission crown gear;
the planetary gear set nests the periphery of the forward transmission crown gear and is meshed with the periphery of the forward transmission crown gear;
the backward transmission crown gear nests the periphery of the forward transmission crown gear, is disposed above the planetary gear set, and is meshed with a gear in the planetary gear set;
the backward transmission crown gear is meshed with a gear in the transmission gear set;
the gear in the transmission gear set is meshed with a gear of the motor;
the motor is connected to the battery;
when the worm moves vertically, the forward transmission crown gear is driven to rotate to drive the gear in the planetary gear set to rotate to cause the backward transmission crown gear to rotate, and then the backward transmission crown gear causes the power generator to generate power by the transmission gear set.

2. The high-energy power generation device for casual shoes according to claim 1, wherein the worm is a dual-tooth worm;
a linear bearing is arranged below each of two support pillars of the dual-tooth worm respectively;
a compression spring sleeves the periphery of the linear spring;
the high-energy power generation device further comprises a spring cover, wherein the spring cover is disposed on the bottom of the forward transmission crown gear, and the bottoms of the two compression springs are disposed on the spring cover respectively.

3. The high-energy power generation device for casual shoes according to claim 2, wherein the planetary gear set comprises a planetary outer gear, a plurality of forward positioning clips and planetary gears;
the planetary outer gear nests the periphery of the forward transmission crown gear;
the forward positioning clips and the planetary gears are disposed on the planetary outer gear alternately;
one ends of the forward positioning clips are fixed on the planetary outer gear, and the other ends thereof clamp the meshing teeth on the side surface of the forward transmission crown gear; and
the planetary gears are conical teeth; one surfaces of the planetary gears are meshed with meshing teeth on the bottom of the forward transmission crown gear, while the other surfaces of the planetary gears are meshed with the meshing teeth on the bottom of the backward transmission crown gear.

4. The high-energy power generation device for casual shoes according to claim 1, wherein, the transmission gear set comprises a first transmission gear and a second transmission gear;
the backward transmission crown gear is meshed with the first transmission gear;
the first transmission gear is meshed with the second transmission gear; and
the second transmission gear is meshed with the gear of the motor.

5. The high-energy power generation device for casual shoes according to claim 3, wherein the high-energy power generation device further comprises a backward positioning clip and an extension spring; and
one end of the backward positioning clip is fixed on the spring cover by the extension spring, and the other end of the backward positioning clip is clamped on meshing teeth on the outer surface of the planetary outer gear.

6. The high-energy power generation device for casual shoes according to claim 1, wherein the high-energy power generation device further comprises two thrust bearings; and
one of the two thrust bearings is disposed above the backward transmission crown gear on the periphery of the worm, while the other of the two thrust bearings is disposed below the forward transmission crown gear.

7. The high-energy power generation device for casual shoes according to claim 1, wherein the high-energy power generation device further comprises an upper cover and a lower cover which can be buckled together;
the battery, the motor, the forward transmission crown gear, the transmission gear set, the backward transmission crown gear and the planetary gear set are disposed between the upper cover and the lower cover;
the upper end of the worm extends out of the surface of the upper cover; and
the high-energy power generation device further comprises a pedal disposed above the worm.

8. The high-energy power generation device for casual shoes according to claim 1, wherein the high-energy power generation device further comprises a circuit board disposed between the motor and the battery.

9. The high-energy power generation device for casual shoes according to claim 8, wherein the battery is configured to charge an external electrical appliance, and charging of the battery is performed using a universal interface or wirelessly.
